(19) United States
(12) Patent Application Publication
(10) Pub. No.: US 2014/0155172 A1
(43) Pub. Date: Jun. 5, 2014

(54) METHOD AND SYSTEM OF MULTIMEDIA GAME PLAY

(71) Applicants: TOMMY STOILKOVICH, Malibu, CA (US); IVAN STOILKOVICH, Malibu, CA (US); JEFFREY BLYSETH, Malibu, CA (US); JAY POPESKI, Malibu, CA (US)

(72) Inventors: TOMMY STOILKOVICH, Malibu, CA (US); IVAN STOILKOVICH, Malibu, CA (US); JEFFREY BLYSETH, Malibu, CA (US); JAY POPESKI, Malibu, CA (US)

(21) Appl. No.: 13/691,644

(22) Filed: Nov. 30, 2012

(51) Int. Cl. G07F 17/32

(52) U.S. Cl. CPC G07F 17/3225
USPC 463/42

(57) ABSTRACT

A multimedia game play is provided. A multimedia game may be created based on a media file. A multimedia game may be a private game, a public game, or a contest game. An entity may create a contest game. A media file may be shared by way of the multimedia game. In one embodiment, a multimedia game is in a live chat session where all the game submissions are synchronized among all the game participants and displayed accordingly. An entity may award winners of a contest game and to promote its business by way of a contest game.

### TECHNICAL FIELD

The present invention relates generally to games and applications, and more particularly, some embodiments relate to social games.

### DESCRIPTION OF THE RELATED ART

Social network systems provide a platform for people to interact, for example, share interests, activities, backgrounds, or real-life connections. A user can specify other users of the social network system as “friends” and interact with “friends.” A user may maintain one or more accounts at various social network systems by various service providers. Many online games operate on the platform provided by the social network systems. The platform allows users of the social network systems to interact with the computer games directly in addition to interacting with each other. However, users of the social network systems and users of online game systems based on social network systems may not interact via multimedia. Privacy issues may arise when a user shares with his or her friends media files online as non-friends will likely to have access to the media files. Further, social network systems or online game systems based on social network systems are not effective for an entity such as a corporation to promote its business.

### BRIEF SUMMARY OF EMBODIMENTS OF THE INVENTION

According to various embodiments of the invention, methods and systems of multimedia game play are provided. In particular, visual communication with social networking in a game play is provided to improve the networking capabilities. In one embodiment, a user may create a multimedia game based on a media file. The multimedia game may be related to identifying a subject of the media file. The user may share the media file with specified friends by inviting them to participate in the multimedia game. Privacy issues may be eliminated as the user may control who may access the multimedia game and the multimedia game file. Further, an entity may also create and manage a multimedia game. Visual communication and artistic expression are combined in the multimedia game such that the entity's advertising, marketing, and Return on Investment (ROI) opportunities are enhanced.

According to an embodiment of the invention, a computer implemented method comprises creating a game based on a media file of a creator, presenting the game to a set of players according to a game option, and receiving a set of game submissions from the set of players. The set of game submissions comprise an attempted identification of a subject of the media file.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a diagram illustrating an exemplary multimedia game system according to one embodiment of the present invention implemented in an example environment.

FIG. 2 is a flow chart illustrating an exemplary method of creating and presenting a multimedia game in accordance with an embodiment of the methods and systems described herein.

FIG. 3 is a flow chart illustrating an exemplary method of a multimedia game play in accordance with an embodiment of the methods and systems described herein.

FIG. 4A illustrates an example of a multimedia game creation interface in accordance with an embodiment of the methods and systems described herein.

FIG. 4B illustrates an example of a multimedia game interface in accordance with an embodiment of the methods and systems described herein.

FIG. 4C illustrates an example of a contest game creation interface in accordance with an embodiment of the methods and systems described herein.

FIG. 4D illustrates an example of a contest game interface in accordance with an embodiment of the methods and systems described herein.

FIG. 5 illustrates an example computing module that may be used in implementing various features of embodiments of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The present invention is directed toward a system and method for providing a multimedia game play. In particular, visual communication with social networking in a game play is provided to improve the networking capabilities. In one embodiment, a user may create a multimedia game based on a media file. The multimedia game may be related to identifying a subject of the media file. The user may share the media file with identified friends through inviting the friends to participate in the multimedia game. Privacy issues may be eliminated as the game creator or manager may control who may access the multimedia game. Further, an entity may also create a multimedia contest game which is open to the public to enhance the entity's advertising, marketing and ROI opportunities.

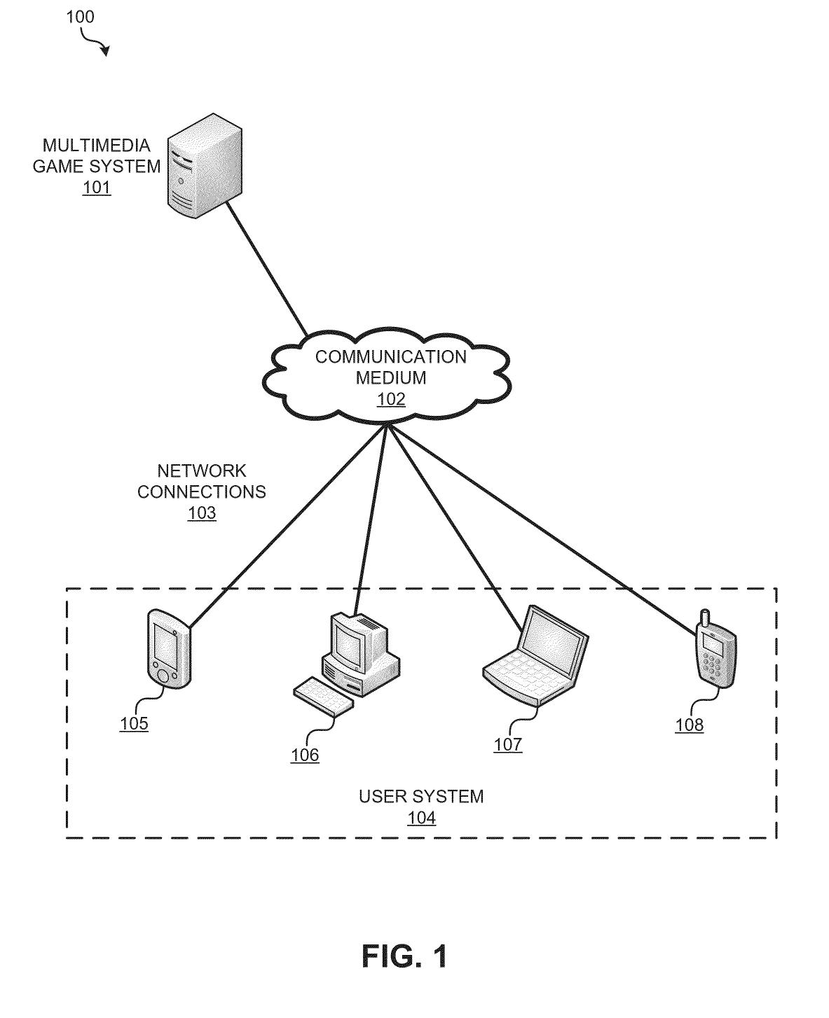

Before describing the invention in further detail, it may be useful to describe a few example environments in which various embodiments of the present invention can be implemented. One such example is that of illustrated in FIG. 1.

FIG. 1 illustrates an exemplary multimedia game system 101 in accordance with one embodiment of the invention, and implemented in an environment 100 comprising various user systems 104 connected to it via a communication medium 102. In various embodiments, the communication medium may be a wired system (e.g., a coaxial cable system, a fiber optic cable system, an Ethernet cable system), or alternatively, the communication medium may be a wireless network system (e.g., a wireless personal area network, a wireless local area network, a cellular network.)

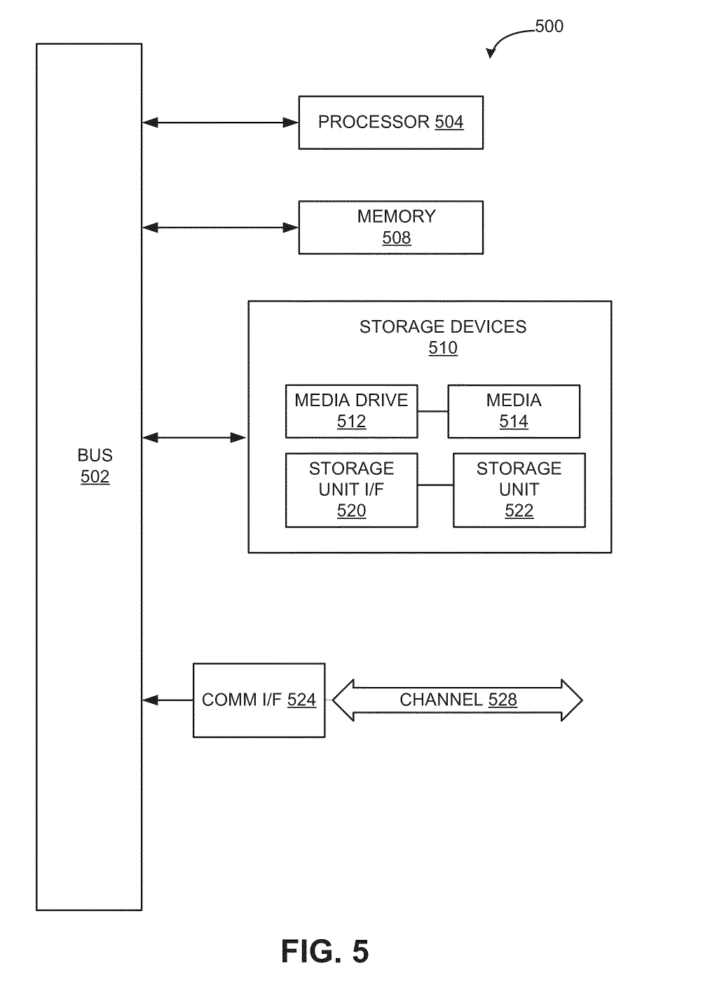

As shown, user systems 104 such as a PDA 105 (e.g., Windows Mobile® device), a desktop computer 106, a laptop computer 107, and a smartphone 108 (e.g., iPhone®), through their respective network connections 103, can either interact directly or indirectly with the multimedia game system 101 to create and to participate in a multimedia game. For example, a network connection 103 includes wired connections (e.g., Digital Subscriber Line (DSL), optical), wireless connections (e.g., Wi-Fi.) In various embodiments, a network connection 130 may include an ad hoc network, an intranet, an extranet, a virtual private network (VPN), a local area network (LAN), a wireless LAN (WLAN), a wide area network (WAN), a portion of the Internet, a portion of the Public Switched Telephone Network (PSTN), a cellular telephone network, or any combination thereof. A network connection 130 needs not necessarily be the same throughout the environment 100. Various user systems 104 (e.g., 105, 106, 107, and 108) and the multimedia game system (101) described within herein may be implemented using the example computer system illustrated in FIG. 5.

A multimedia game can be hosted by the multimedia game system 101, which may be accessed by a user using any user system 104 (e.g., 105, 106, 107, and 108). A user may be an individual, or an entity (e.g., a group, a corporation, or a business). A user may have an account associated with the multimedia game system 101, wherein the account may contain a variety of information associated with the user (e.g., the user's personal information including the person's preferred name, the username, the user's preferences, hobbies, interests, games owned by the user, games played by the user, the user's friends, the user's group.) The user further has a profile associated with the account. In some embodiments, the user may participate in multiple multimedia games at any time by using one or more user accounts. These user accounts may or may not be associated.

A user may have a set of friends on the multimedia game system 101, as such, the user's game account may be associated with a list of friends. The user may manage each friend's access to the user's account information. A user may also manage a set of friend groups and assign the set of friends into different friend groups. A friend may be assigned to multiple friend groups. A user may search for a friend by email, username or other information that identifies the friend. If a friend does not have an account on the multimedia game system 101, the user may invite the friend. Once the friend sets up an account on the multimedia game system 101, the user may receive a notification and the friend will be added to the user's list of friends. In various embodiments, the user may also add friends from other social network systems or other social-network based game systems.

In various embodiments, a user may access, create, manage, participate in a multimedia game via a user system 104. The user system 104 can display any interface related to the multimedia game and allow a user to interact with a multimedia game. For example, the user system 104 may be configured to receive a game input from a user, to transmit the game input to the multimedia game system 101, and to receive game instructions from the multimedia game system 101. In one embodiment, examples of interfaces related to the multimedia game include a multimedia game creation interface, a multimedia game interface, a multimedia game invitation interface, and a multimedia game management interface. The interfaces may have different designs for different user systems. One of ordinary skill in the art will understand that other interfaces related to the multimedia game may be created to facilitate the multimedia game experience. In one embodiment, a user may download a client component of a multimedia game. The client component may be executed locally at a user system 104, whereas the multimedia game system 101 may provide back-end support for the client component and may be responsible for maintaining the multimedia game application data, processing inputs from users, updating and synchronizing displays among various users, and transmitting instructions various user system 104.

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention.

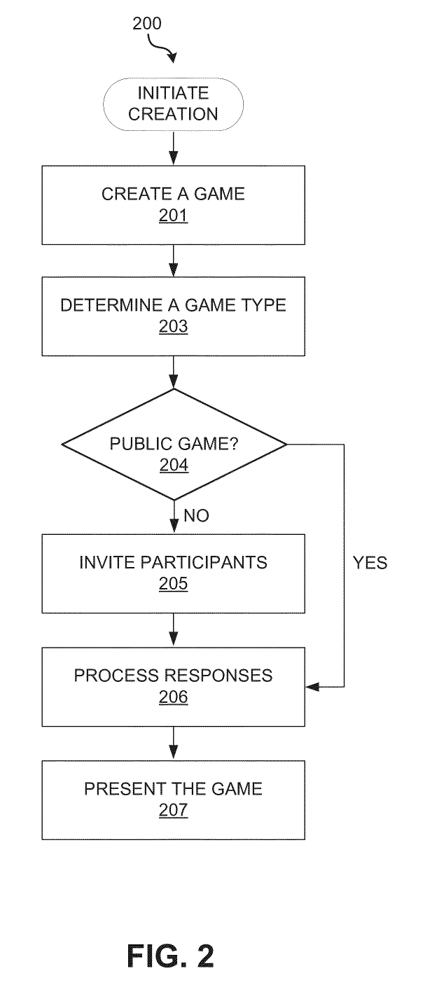

FIG. 2 is a flow chart illustrating an exemplary method 200 of creating and presenting a multimedia game in accordance with an embodiment of the methods and systems described herein. At step 201, the method creates a multimedia game based on a media file according to a game option provided by the user. A media file may be a photo, a video, an audio, an animation, etc. In one embodiment, the method may edit the media file according to a user's instruction, such as changing the color scheme of the media file, cropping the media file, etc. The game option defines attributes of a multimedia game including the game category (e.g., public game, private game, or contest game), the game participants (e.g., everyone or certain users), the game format (e.g., multiple choice or short answers), the game layout (e.g., whether and when hint should be released, how long comments should be displayed, the guideline to determine a game winner, and the award.) In one embodiment, only an entity may create a contest type game, in which case the winners are awarded. As such, the entity may enhance its advertising, marketing, and other opportunities to promote its business.

In various embodiments, the multimedia game is created to identify a subject of the media file. For example, in a multimedia game, a user may ask a question such as “where am I?,” “what is this?,” and “who is this?” In one embodiment, the method allows a user to provide additional information that may facilitate the multimedia game, such as a hint. Exemplary hints include a zip code, a description of a characteristic of the subject matter, and another subject matter related to the media file. In further embodiments, the method may create a media file and store the media file locally at various user system 104 or under the user's account on the multimedia game system 101.

In various embodiments, a multimedia game may be a public game, a private game, or a contest. A public game is the multimedia game that is open to every registered user on the multimedia game system 101. In other words, all the users have an account on the multimedia game system 101 have access to and may participate in any public game. A private game is the multimedia game that is open only to certain users. The game creator or manager may identify certain users and limit the access only to those identified users. A contest game is the multimedia game that is created by en entity other than an individual. An entity may promote advertising, marketing, and Return on Investment (ROI) opportunities by way of a contest game. An entity may provide entity-related information on the game interface. In some embodiments, a user playing a contest game may comment on the entity, store the entity to a list of favorite businesses under the user's account on the multimedia game system or social networks, recommend the entity to the user's friends on the multimedia game system or social networks, or engage in other activities that may promote the entity. In various embodiments, the entity may create incentives to award winners of the corporate game thereby to publicize the entity and to promote the business. Winners of a corporate game may contact the entity for awards or may simply download a voucher or a coupon.

Still referring to FIG. 2, at step 203, the method determines the game category according to the game option provided by the user. By choosing a game category, the creator of the game or the user who manages the game may determine the prospective game participants. In various embodiments, the creator may identify a set of friends or a set of friend groups as the prospective game participants. At step 205, subsequent to determining that a game is a private game, the method invites the prospective game participants identified by the user. In various embodiments, the method may push a notice such as the game invitation interface to every prospective game participant on the respective user system 104 if the prospective game participant is online or logged in. Otherwise, if a prospective game participant is offline or logged out, the method may notify the prospective game participant once he or she is online or logged in. Alternatively, the method may notify the prospective game participants via various means (e.g., email or text message.) In various embodiments, the method presents a list of games that are in session to a user, which may include randomly-selected public games and contests, as well as private games that are being played or are created by the user. In one embodiment, the method presents these games by using the media files. In further embodiments, the method may present a list of games according to the user's preferences stored in the user's account.

With further reference to FIG. 2, at step 206, the method processes a response to the game invitation from a prospective game participant. In various embodiments, a prospective game participant may accept, decline, or ignore a game invitation. A prospective game participant becomes a game participant when he or she accepts the game invitation. At step 207, the method presents the multimedia game to the game participants. In one embodiment, the method stores a variety of information (e.g., the user's preferences, hobbies, interests, games owned by the user, games played by the user, the user's friends, the user's group) under the user's account on the multimedia game system 101. The method may suggest games to the user based on the stored variety of information. In further embodiments, the method presents game statistics (e.g., the game participants, the number of game participants, the latest game submission, the rank of the game among all the games) of a particular game to the game creator or the user who manages the game.

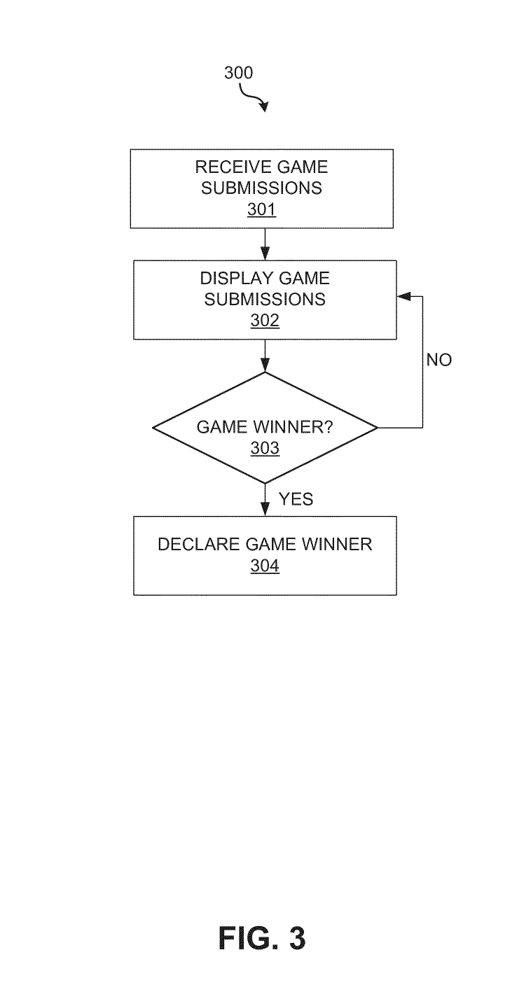

FIG. 3 is a flow chart illustrating an exemplary method 300 of a multimedia game play in accordance with an embodiment of the methods and systems described herein. At step 301, the method receives game submissions from the game participants. In one embodiment, a game creator may define the game submissions in the game option. In various embodiments, the game submissions are in a format according to the game option defined by the game creator, which may be an answer or a comment to the multimedia game or both. At step 302, the method displays a multimedia game interface showing all the game submissions from the game participants. In one embodiment, the messages are displayed on a message board or as a live chat session, where the method synchronizes the multimedia game interface among all the game participants such that the game submissions from various game participants are displayed real time. The game creator may regulate how the game submissions are displayed on the multimedia game interface, for example, certain content may be prohibited and different icons may be used for attempted answers and comments.

At step 303, the method determines whether there is a winner of the game. In some embodiments, the method receives an instruction from the game creator or the game manager identifying winner(s) of a multimedia game. In some embodiments, the method determines winner(s) of a game according to the game option. At step 304, the method declares the game winner(s). In various embodiments, the method declares the game winner on the multimedia game interface to all the game participants. In further embodiments, the method declares the game winner on the multimedia game interface to the winner and the game creator or the user who manages the game. In various embodiments, the method terminates the game after all the winners are declared and may display the game submission on the multimedia game interface for a certain amount of time according to the game option. The method may also terminate a game after a predetermined time has lapsed according to the game option even though there is no winner. In various embodiment, the method may instruct winners of a contest game on how to claim awards. In one embodiment, the method may present the award through an interface on the winner's users system, such as a coupon code. In further embodiments, a winner may be notified and instructed to contact the entity to claim the award by various means including notification through an interface on the user's system, email, SMS, snail mails, or other communication means.

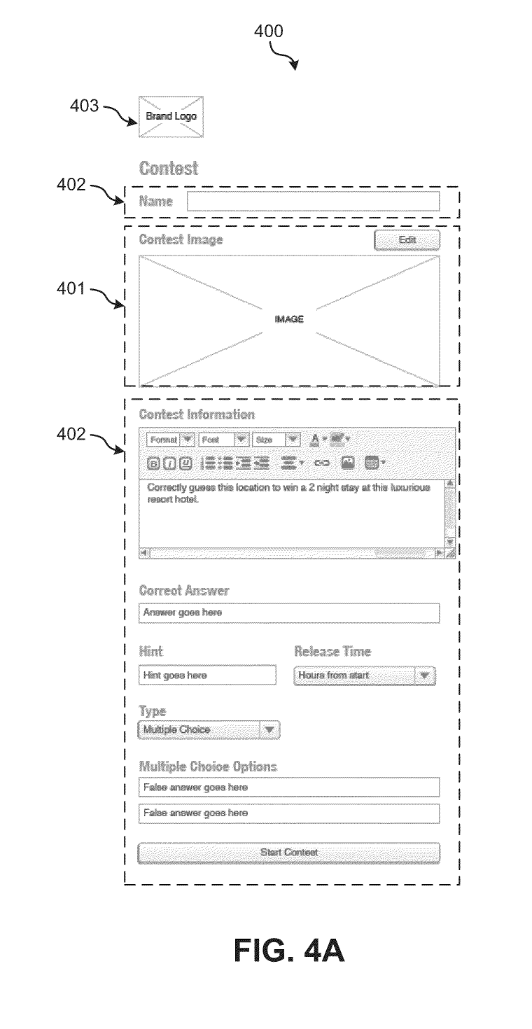

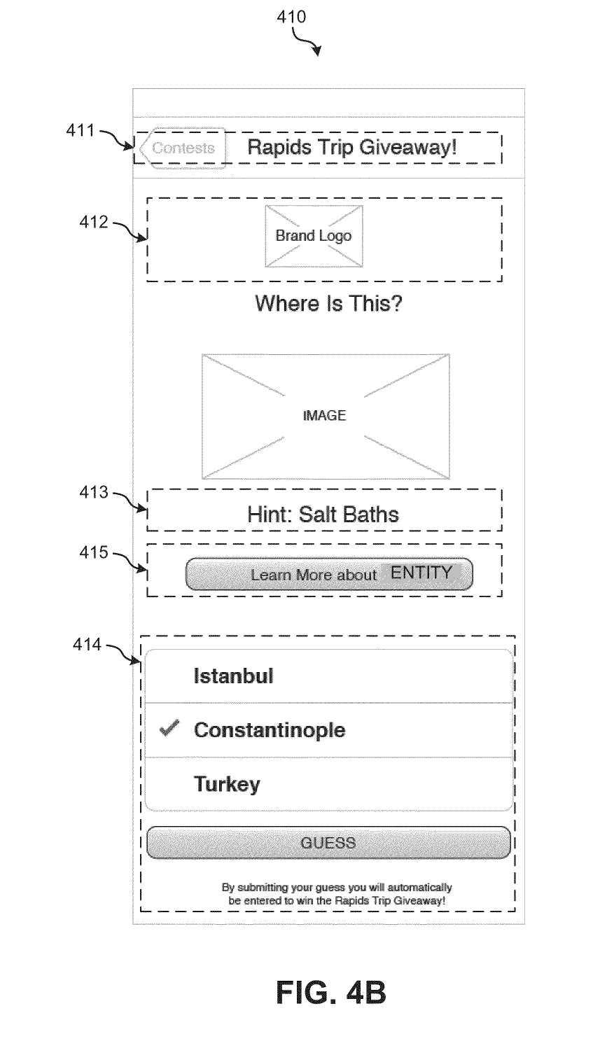

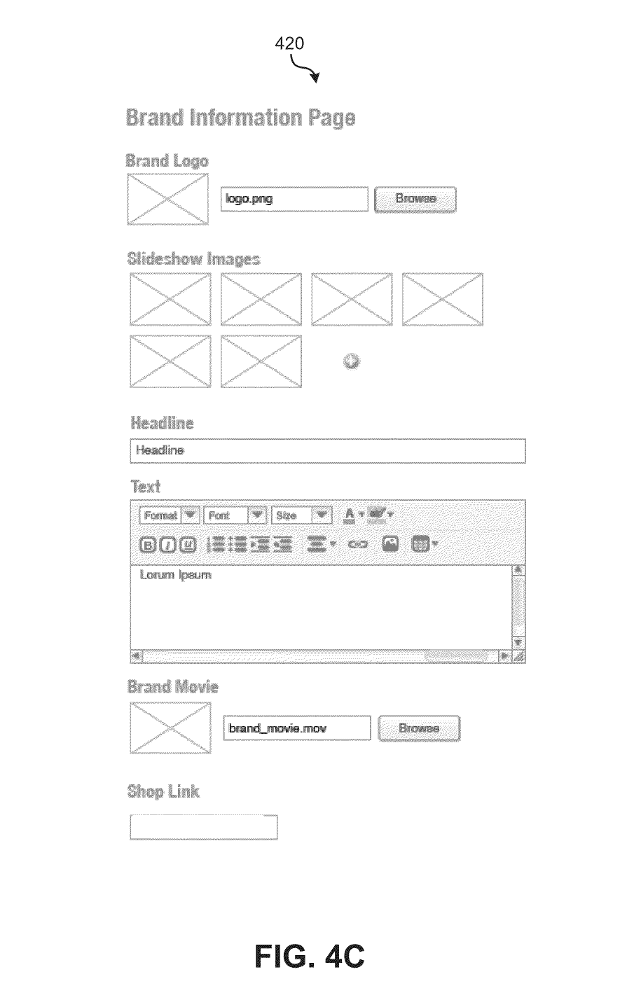

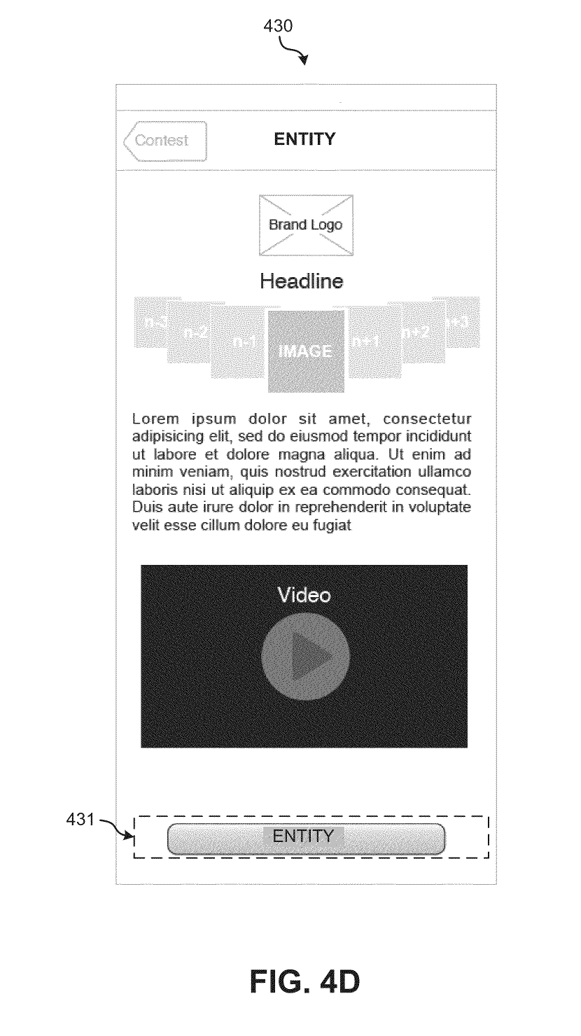

FIG. 4A illustrates an example of a multimedia game creation interface 400 in accordance with an embodiment of the methods and systems described herein. The illustrated multimedia game creation interface may be a web application or a mobile application and may be accessed via different user systems. In various embodiments, an entity may create a contest game. Interface 400 comprises a media file selection panel 401 and a game option panel 402. In the illustrated example, an entity may select an image in order to create a contest game. The entity may edit the name, description of the game and other information included in the game option (e.g., the guideline for determining the winner of the contest, whether a hint should be released, when the hint should be released, the game category). The entity may further include a logo of the entity 403 or other descriptions of the entity so that the logo 403 will be displayed on the multimedia game interface to all the game participants. As such, the contest game promotes the entity's business.

FIG. 4B illustrates an example of a multimedia game interface 410 in accordance with an embodiment of the methods and systems described herein. The game interface 410 displays the game title 411 according to the game creator's game option entry. The game interface 410 displays a brand logo 412 if the game creator, such as an entity, decides to include a brand logo when creating the game. In the illustrated example, the game interface 410 releases a hint 413, which provides additional information that may assist a game participant, at a time point determined by the game creator. In the illustrated embodiment, the game interface 410 displays the choices to the multiple choice question, which a game participant may select. By clicking the “Guess”, a user participates in the contest game.

FIG. 4C illustrates an example of a contest game creation interface 420 in accordance with an embodiment of the methods and systems described herein. A contest game allows an entity to promote its businesses. In one embodiment, an entity may provide further entity information such as a brand, descriptions of its business and other business promotion information. In the illustrated example, the entity may provide media files about the entity such as a brand logo, slideshow images, and movies, which will be displayed on the multimedia game interface along with descriptions of the entity and one or more web links.

FIG. 4D illustrates an example of a contest game interface 430 in accordance with an embodiment of the methods and systems described herein. The game interface 430 will be displayed when a user clicks 415 as illustrated on FIG. 4B. A user may be directed to the entity's homepage when clicking 431 as illustrated on FIG. 4D.

As used herein, the term set may refer to any collection of elements, whether finite or infinite. The term subset may refer to any collection of elements, wherein the elements are taken from a parent set; a subset may be the entire parent set. As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 5. Various embodiments are described in terms of this example-computing module 500. After reading this description, it will become apparent to a person skilled in the relevant art how to implement the invention using other computing modules or architectures.

Referring now to FIG. 5, computing module 500 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 500 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 500 might include, for example, one or more processors, controllers, control modules, or other processing devices, such as a processor 504. Processor 504 might be implemented using a general-purpose or special-purpose processing engine such as, for example, a microprocessor, controller, or other control logic. In the illustrated example, processor 504 is connected to a bus 502, although any communication medium can be used to facilitate interaction with other components of computing module 500 or to communicate externally.

Computing module 500 might also include one or more memory modules, simply referred to herein as main memory 508. For example, preferably random access memory (RAM) or other dynamic memory, might be used for storing information and instructions to be executed by processor 504. Main memory 508 might also be used for storing temporary variables or other intermediate information during execution of instructions to be executed by processor 504. Computing module 500 might likewise include a read only memory (“ROM”) or other static storage device coupled to bus 502 for storing static information and instructions for processor 504.

The computing module 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a floppy disk drive, a magnetic tape drive, an optical disk drive, a CD or DVD drive (R or RW), or other removable or fixed media drive might be provided. Accordingly, storage media 514 might include, for example, a hard disk, a floppy disk, magnetic tape, cartridge, optical disk, a CD or DVD, or other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing module 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory module) and memory slot, a PCMCIA slot and card, and other fixed or removable storage units 522 and interfaces 520 that allow software and data to be transferred from the storage unit 522 to computing module 500.

Computing module 500 might also include a communications interface 524. Communications interface 524 might be used to allow software and data to be transferred between computing module 500 and external devices. Examples of communications interface 524 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 524 might typically be carried on signals, which can be electronic, electromagnetic (which includes optical) or other signals capable of being exchanged by a given communications interface 524. These signals might be provided to communications interface 524 via a channel 528. This channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium,” “computer readable medium,” and “computer usable medium” are used to generally refer to media such as, for example, memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 500 to perform features or functions of the present invention as discussed herein.

While various embodiments of the present invention have been described above, it should be understood that they have been presented by way of example only, and not of limitation. Likewise, the various diagrams may depict an example architecture or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A computer-implemented method, comprising:
creating a game based on a media file according to a game option of a creator;
presenting the game to a set of players according to the game option; and
receiving a set of game submissions from the set of players, wherein the set of game submissions comprise an attempted identification of a subject of the media file, and wherein the received set of game submissions are all displayed real time in a synchronized game interface in a manner defined by creator-determined regulations.

2. The computer-implemented method of claim 1, wherein the set of game submissions further comprise a comment to the game.

3. The computer-implemented method of claim 1, further comprising creating the media file and storing the media file.

4. The computer-implemented method of claim 1, wherein the creator is an individual, further comprising receiving a determination of a game winner from the creator.

5. The computer-implemented method of claim 1, wherein the creator is an entity and the game option comprises a first instruction to determine a game winner and a second instruction to award the game winner.

6. The computer-implemented method of claim 1, wherein the game option comprises an instruction to send a game invitation to a player, further comprising processing a response to the game invitation from a player.

7. The computer-implemented method of claim 1, wherein the game option comprises a game category.

8. The computer-implemented method of claim 1, further comprising presenting the set of game submissions on a message board.

9. The computer-implemented method of claim 1, further comprising providing game statistics to the creator.

10. The computer-implemented method of claim 1, further comprising:
creating a profile of the creator; and
recommending a second set of games to the creator based on the profile.

11. A multimedia game system comprising:
an interface to communicate with a creator and a set of players;
a processor coupled to the interface and to a non-transitory computer readable medium; and
the computer executable program code embodied on the non-transitory computer readable medium configured to cause the processor to:
create a game based on a media file of the creator according to a game option;
present the game to the set of players according to the game option; and
receive a set of game submissions from the set of players, wherein the set of game submissions comprise an attempted identification of a subject of the media file, and wherein the received set of game submissions are all displayed real time in a synchronized game interface in a manner defined by creator-determined regulations.

12. The multimedia game system of claim 11, wherein the set of game submissions further comprise a comment to the game.

13. The multimedia game system of claim 11, wherein the computer executable program code is further configured to cause the processor to create the media file and store the media file.

14. The multimedia game system of claim 11, wherein the creator is an individual, and the computer executable program code is further configured to cause the processor to receive a determination of a game winner from the creator.

15. The multimedia game system of claim 11, wherein the creator is an entity and the game option comprises a first instruction to determine a game winner and a second instruction to award the game winner.

16. The multimedia game system of claim 11, wherein the game option comprises an instruction to send a game invitation to a player and the computer executable program code is further configured to cause the processor to process a response to the game invitation from a player.

17. The multimedia game system of claim 11, wherein the game option comprises a game category.

18. The multimedia game system of claim 11, wherein the computer executable program code is further configured to cause the processor to present the set of game submissions on a message board.

19. The multimedia game system of claim 11, wherein the computer executable program code is further configured to cause the processor to provide game statistics to the creator.

20. The multimedia game system of claim 11, wherein the computer executable program code is further configured to cause the processor to:
create a profile of the creator; and
recommend a second set of games to the creator based on the profile.
